(19) United States
(12) Patent Application Publication
(10) Pub. No.: US 2004/0056493 A1
(43) Pub. Date: Mar. 25, 2004

(54) Lifting devices for flying form table trusses

(76) Inventor: Peter Vanagan, Vancouver (CA)

Correspondence Address: LONG AND CAMERON, SUITE 1401 - 1166 ALBERNI STREET, VANCOUVER, BC, V6E 3Z3, CA

(21) Appl. No.: 10/455,311

(22) Filed: Jun. 6, 2003

Related U.S. Application Data
(60) Provisional application No. 60/387,572, filed on Jun. 12, 2002.

(51) Int. Cl. B66C 1/22

(52) U.S. Cl. 294/67.21

(57) ABSTRACT

A lifting device for suspending a flying form table truss has a horizontal lower truss arm for insertion into the flying truss, a horizontal upper truss arm extending above and parallel to the lower truss arm, an intermediate vertical section connecting one end of the upper truss arm to one end of the lower truss arm, and a trolley, provided with a crane hook connector, on a trolley track extending along the top of the upper truss arm. By adjusting the position of the trolley along the upper truss arm, the crane hook connector can be located above the centre of gravity of the flying form table truss.

### FIELD OF THE INVENTION

The present invention relates to lifting devices for flying form table trusses.

### DESCRIPTION OF THE RELATED ART

Flying form table trusses are employed as flying shoring forms in building construction, and are provided with a pair of parallel trusses supporting a table, with bracing between the trusses, and with screw jack legs for supporting the trusses, as disclosed, for example, in U.S. Pat. No. 5,560,160, issued Oct. 1, 1996 to the present inventor, then known as Peter Vladikovic.

In use, the screw jack legs are supported on a previously cast floor of a building, with the trusses extending upwardly from the screw jacks and supporting the table horizontally on the top of the trusses. After a new floor of the building has been cast on the table, the screwjack legs are released and the flying form table, with its trusses, is withdrawn horizontally from beneath the newly cast floor, and raised by a crane to a position on top of the newly cast floor, ready for the casting of a still further floor.

It has also been proposed to provide a lifting device with a lower arm for insertion into the flying form table truss, an upper arm extending above and parallel to the lower arm, an intermediate section connecting the upper and lower arms and a crane cable connector on the upper arm.

It has been found, in practice, that the suspension of the flying form table and this lifting device by a crane is problematical, because it is difficult or even impossible to locate the center of gravity of the flying form table truss and the lifting device, or the lifting device alone, when the flying form table truss is not being lifted, below the outer end of the crane boom.

### BRIEF SUMMARY OF THE INVENTION

The present invention it is based on the concept of providing a lifting device which can be located between the flying form table truss, on the one hand, and a crane cable, on the other hand, which enables a point of connection of the lifting device to the crane cable to be adjustable in position along the lifting device so that it can be adjustably located above the center of gravity of the flying form table truss and the lifting device or of the lifting device alone.

More particularly, according to the present invention there is provided a lifting device for use in suspending a flying form table truss, the lifting device comprising a lower arm for insertion into the flying form table truss, an upper arm extending above and parallel to the lower arm, an intermediate vertical section connecting one end of the upper arm to one end of the lower arm, and a crane cable connector which is adjustable along the upper arm.

In a preferred embodiment of the invention, the crane cable connector comprises a crane hook connector mounted on a trolley and the trolley can run along a track extending along the top of the upper arm.

When the lifting device according to the present invention it is in use, the trolley can be driven along its track so as to correctly adjust the position of the crane hook relative to the flying form table truss and the lifting device and thereby to facilitate correct balancing of the table truss in a horizontal condition while the table truss is suspended from the crane.

### BRIEF DESCRIPTION OF THE DRAWINGS

The present invention will be more readily understood from the following description of a preferred embodiment thereof given, by way of example, with reference to the accompanying drawings, in which:

FIG. 1 shows a view in side elevation of a flying form table truss provided with a lifting device according to the present invention;

FIG. 1A shows a view in side elevation of the lifting device of FIG. 1 suspended from the cable of a crane;

FIG. 2 shows a view in side elevation of the lifting device of FIG. 1 provided with a wireless remote control system;

FIG. 3 shows a diagrammatic view taken in vertical cross-section through the apparatus of FIG. 1;

FIGS. 4 and 5 show a top plan view and an underneath plan view, respectively, of an upper truss arm of the lifting device of FIG. 2;

FIG. 5A shows, in perspective, of a broken-away end portion of the truss of FIG. 4;

FIG. 6 shows a top plan view of the lower truss arm of the lifting device of FIG. 2;

FIG. 7 shows an underneath plan view of the lower truss arm of the lifting device of FIG. 6;

FIG. 7A shows, in perspective, of a broken-away end portion of the truss of FIG. 7;

FIG. 8 a view of a truss forming an intermediate section of the lifting device of FIG. 2, taken in the direction of the arrow A1 of FIG. 2;

FIG. 9 shows a view of the intermediate section of FIG. 8, taken in the direction of the arrow A2 of FIG. 2;

FIG. 9A shows, in perspective, of a broken-away end portion of the truss of FIG. 8;

FIG. 10 shows a view taken in cross-section along the line 10-10 of FIG. 2;

FIG. 11 shows a view in side elevation of a trolley forming part of the lifting device of FIG. 1;

FIG. 12 shows a view in end elevation of the trolley of FIG. 11; and

FIG. 13 shows a view in vertical cross-section of some components of the trolley of FIG. 11.

### DESCRIPTION OF THE PREFERRED EMBODIMENT

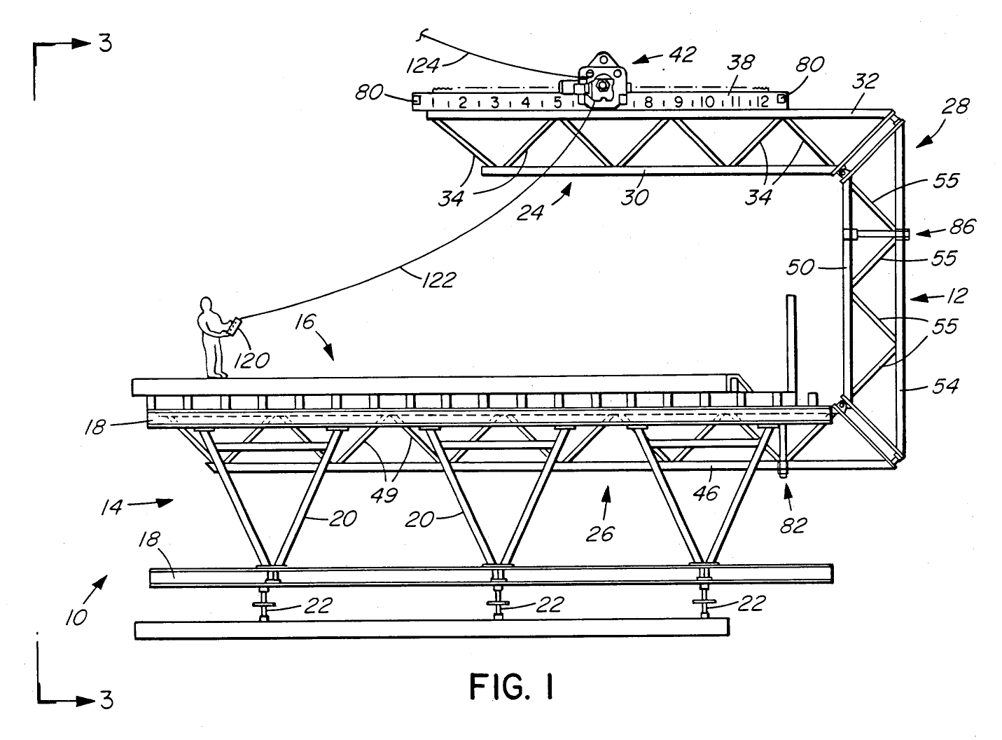

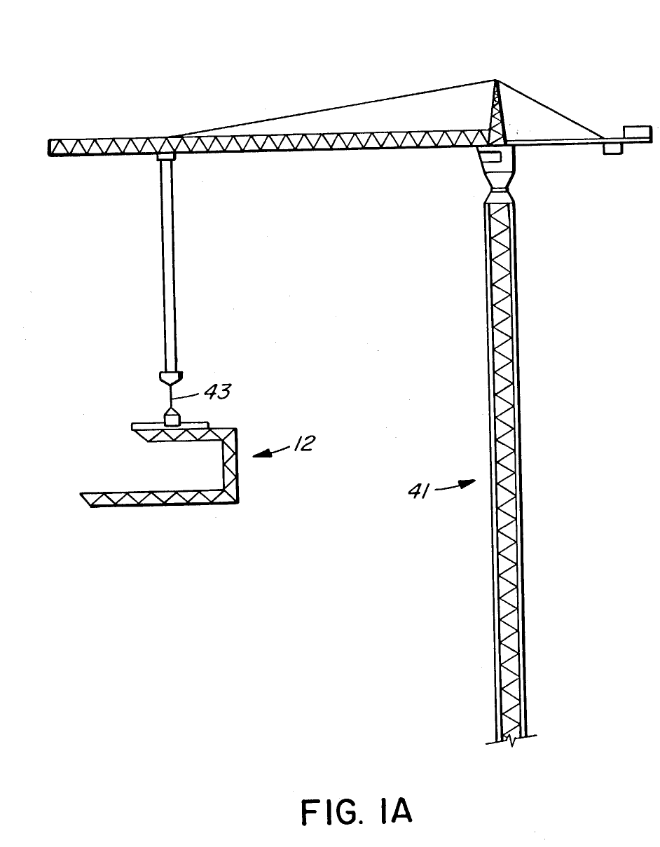

In FIG. 1 of the accompanying drawings, there is shown a flying form table truss indicated generally by reference numeral 10, and a lifting device embodying the present invention, which is indicated generally by reference numeral 12.

The flying form table truss 10 is identical to that disclosed and illustrated in the aforesaid U.S. Pat. No. 5,560,160, the disclosure which is incorporated herein by reference, and will therefore not be described in detail herein. This flying form table truss 10 comprises a pair of elongate, laterally spaced, parallel, vertical support structure truss component 14, only one of which is shown in the drawings, which support, on their tops, a flying form table indicated generally by reference numeral 16. Each of these support truss components 14 comprises a vertically spaced pair of longitudinal tubular beams 18, which are interconnected by angled connecting tubes 20. The support structure truss components 14 are each supported on three screw jacks 22.

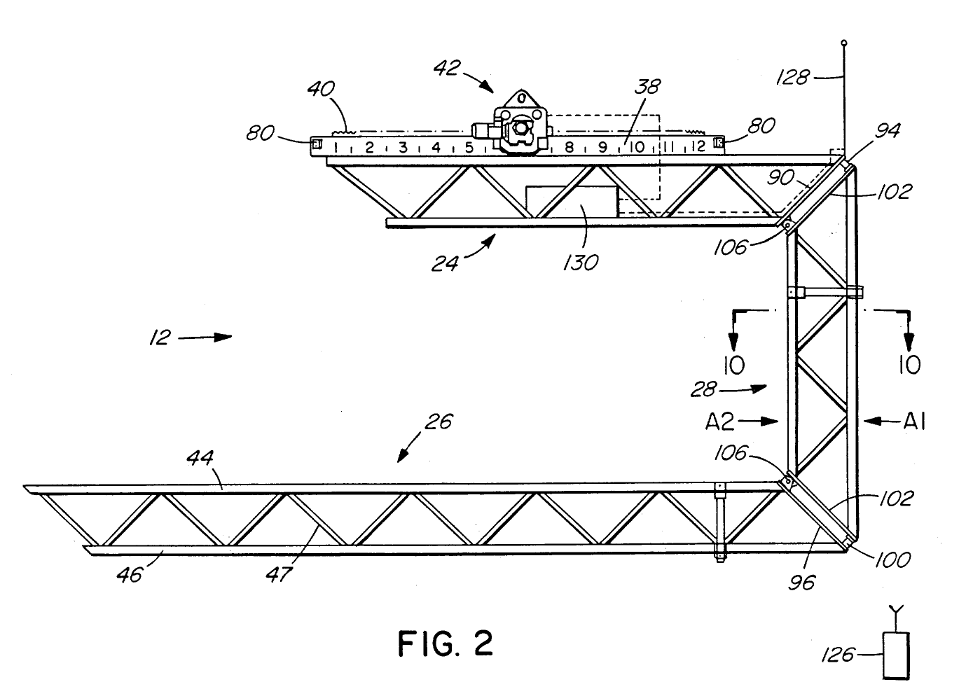

The lifting device 12, which is shown in greater detail in FIG. 2, has a horizontal upper truss arm indicated generally by reference numeral 24, a lower horizontal truss arm indicated generally by reference numeral 26, which extends below and parallel to the upper truss arm 24, and a vertical intermediate section, in the form of an intermediate truss arm indicated generally by reference numeral 28, which as viewed in FIG. 2 interconnects right hand ends of the upper and lower truss arms 24 and 26, which ends are opposite from free ends of the upper and lower truss arms 24 and 26.

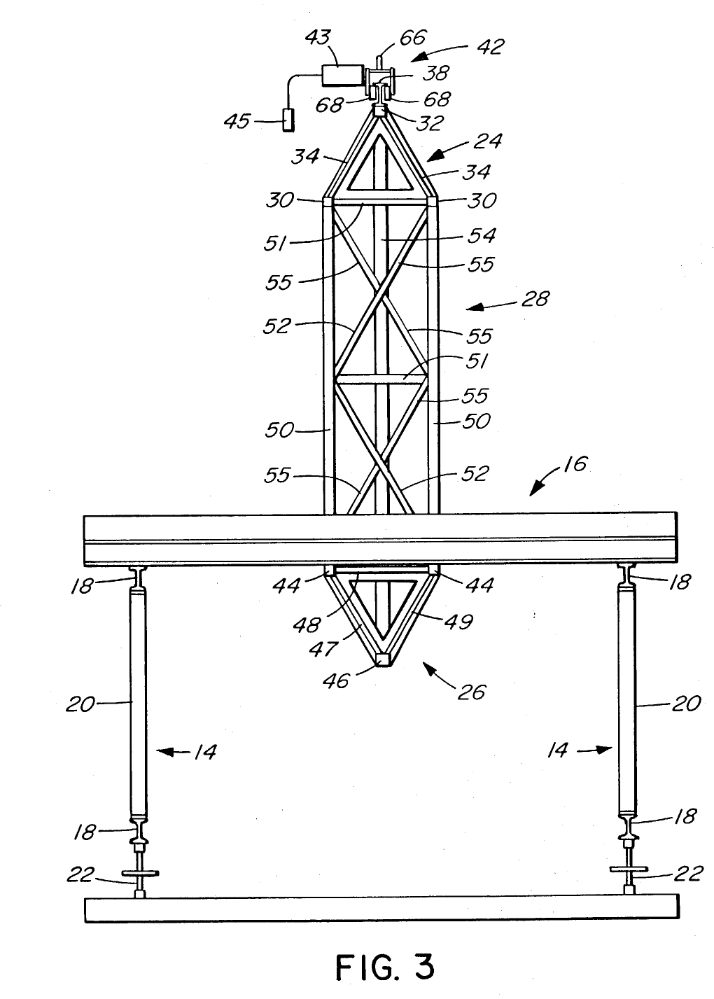

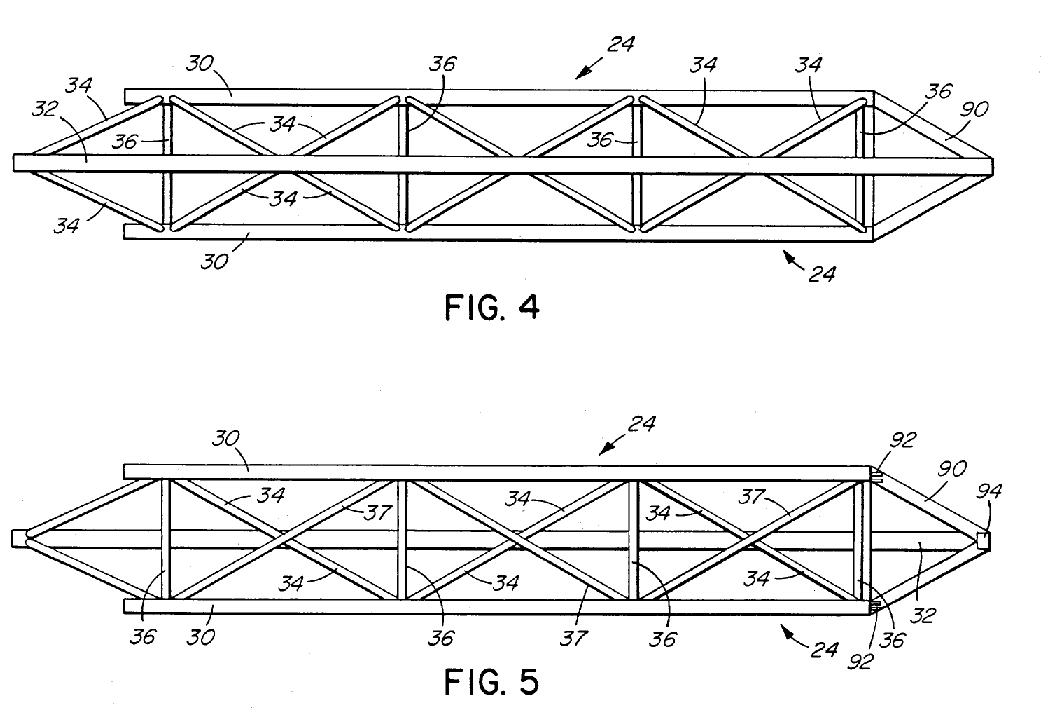

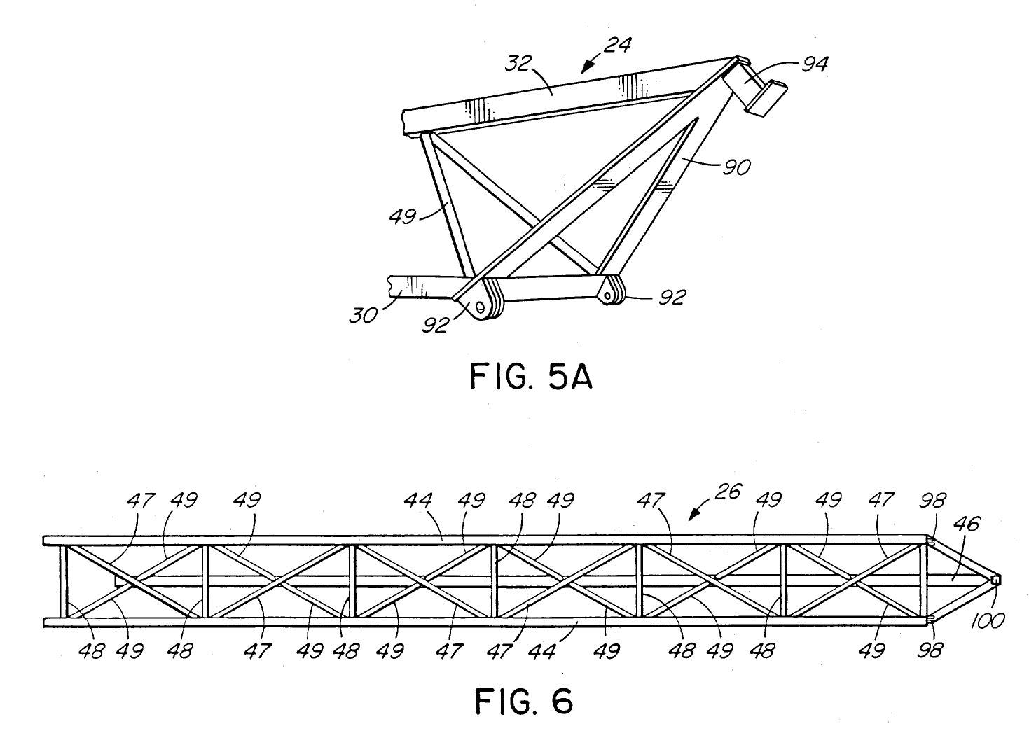

The upper truss arm 24, the cross-section of which is shown in FIG. 3, is of triangular cross-sectional shape and, as shown in FIGS. 4 and 5, has a pair of lower, horizontally spaced tubular beam members 30, an upper tubular beam member 32 and angled tubes 34 connecting the lower tubular beam members 30 to the upper tubular beam member 32. The lower tubular beam members 30 are interconnected by tubular transverse braces 36 and by angled tubes 37.

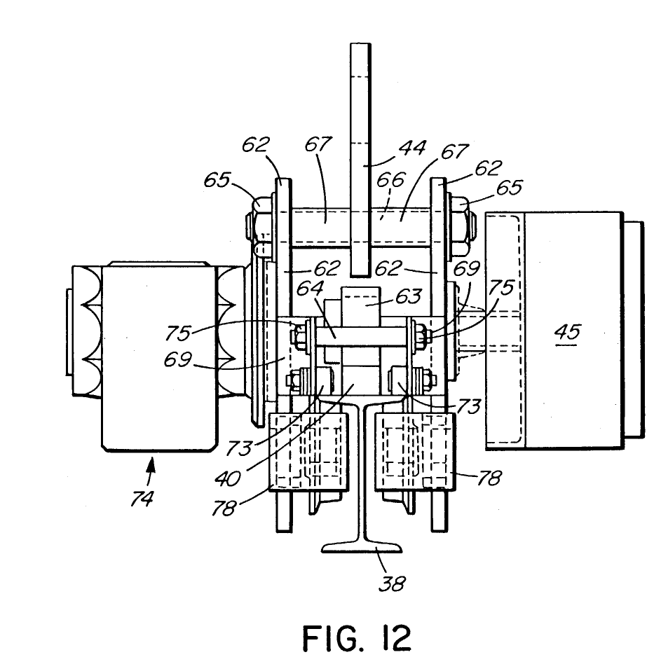

An I-beam 38 (FIGS. 1 and 3) extends longitudinally along the top of the tubular beam 32 on the upper truss arm 24, and a toothed rack 40 is welded to the I-beam 38 along the top of the I-beam 38. The I-beam 38 and the rack 40, which to facilitate illustration of the apparatus have been omitted from FIG. 4, form a track for a trolley or carriage indicated generally by reference numeral 42 which, as described in greater detail below, can be driven to and fro along the I-beam 38 and the rack 40 by an electric motor indicated generally by reference numeral 76 (FIG. 11) controlled by a control unit 45 (FIG. 12). The trolley 42 includes a crane hook connector 44 for connection to the hook (not shown) of a crane cable 43 as shown in FIG. 1A, in which a crane is indicated generally by reference numeral 41.

The I-beam 38 is provided with markings in the form of numerals 1, 2, etc., which are spaced apart along the I-beam as shown in FIG. 1 and which are sufficiently large as to be remotely visible, i.e. visible by an operator on the ground. These marking facilitate return of the trolley to a previous position after the lifting device 12, having been removed from and lifted without the flying form table truss 10, is re-engaged with the flying form table truss 10 to lift it again.

The lower truss arm 26 is of triangular cross-section, having a pair of horizontally spaced upper tubular beams 44 (FIGS. 3, 6 and 7), which are connected by angled tubes 47 and transverse braces 48, a horizontal lower tubular beam 46 and angled tubes 49 interconnecting the upper tubular beams 44 and the lower tubular beam 46.

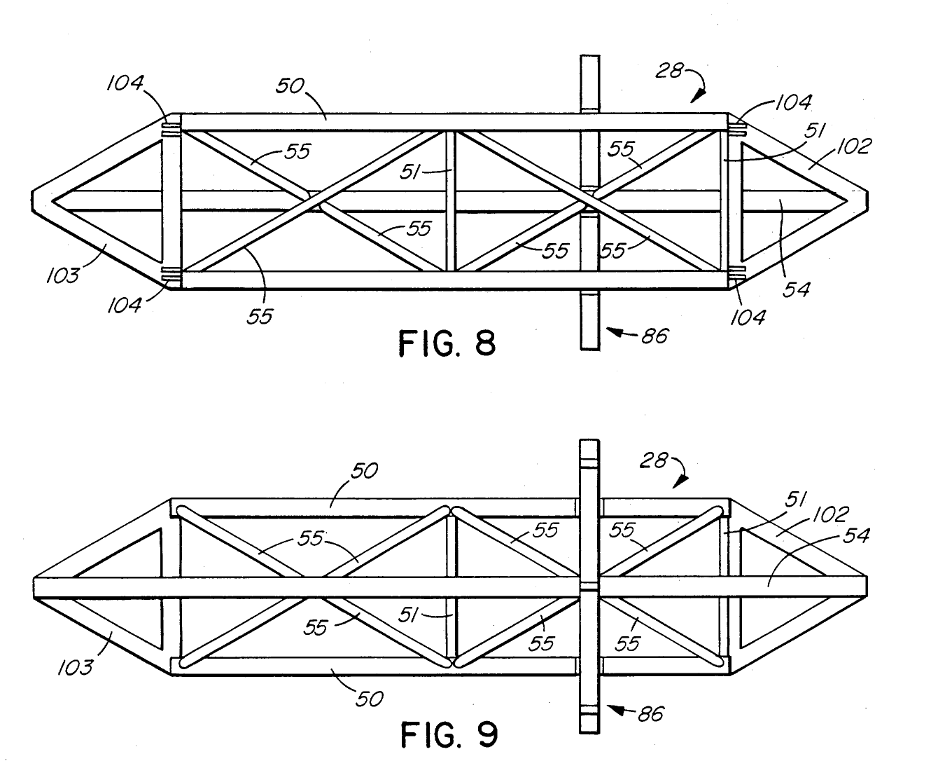

The vertical intermediate section 28 (FIGS. 3, 8 and 9) is also of triangular cross-section and has a pair of parallel tubular beams 50, connected by transverse braces 51 and angled tubes 52, a parallel tubular beam and angled tubes 55 connecting the tubular beams 50 to the tubular beam 54.

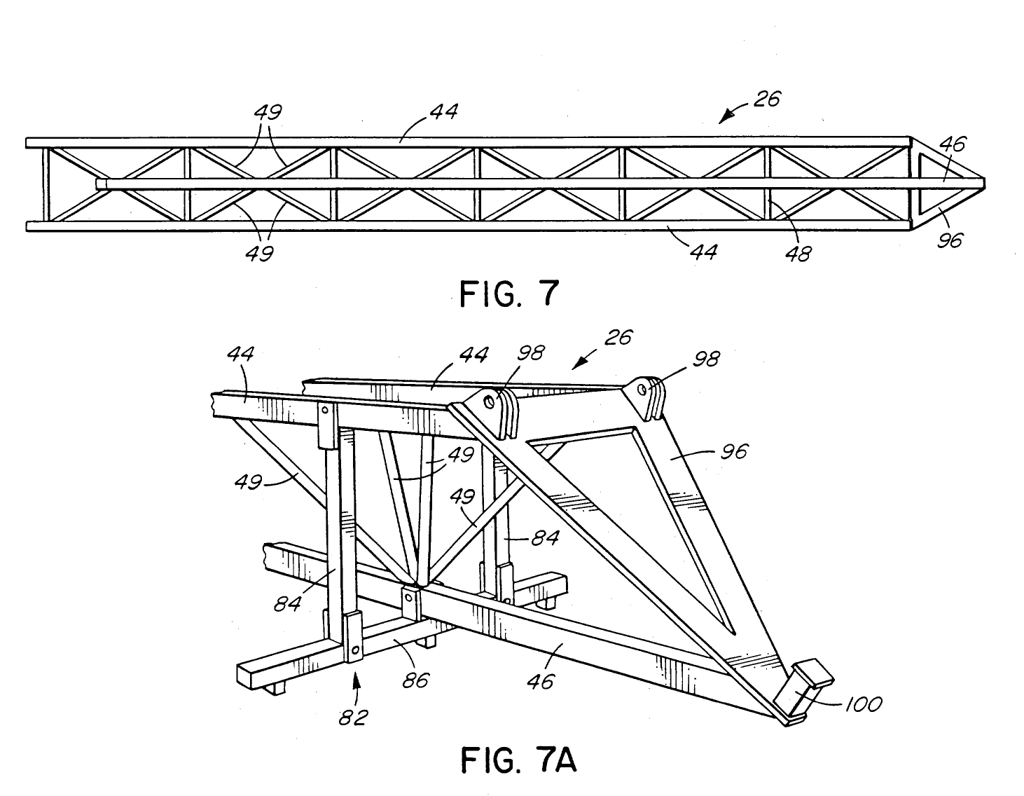

As shown in FIG. 7A, the lower truss arm 26 has a landing arm indicated generally by reference numeral 82, which is formed by a pair of posts 84 depending from the beams 44 and a cross-member 86 connected to the lower ends of the posts 84 and extending beneath the beam 46. This landing arm 82 serves to support the lower truss arm 26 against falling sideways when the lower truss arm 26 is lowered onto the ground.

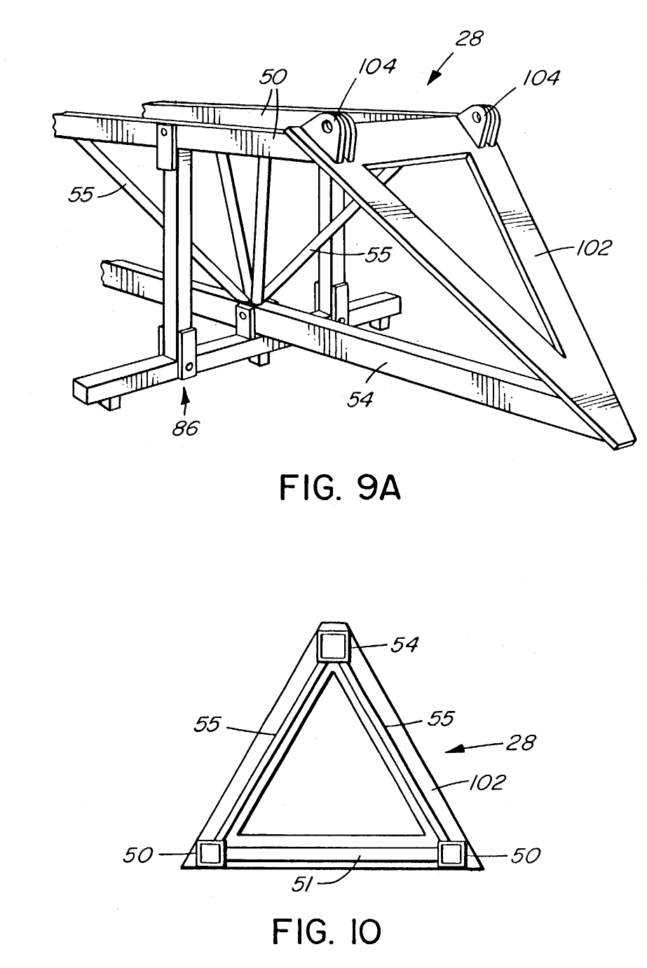

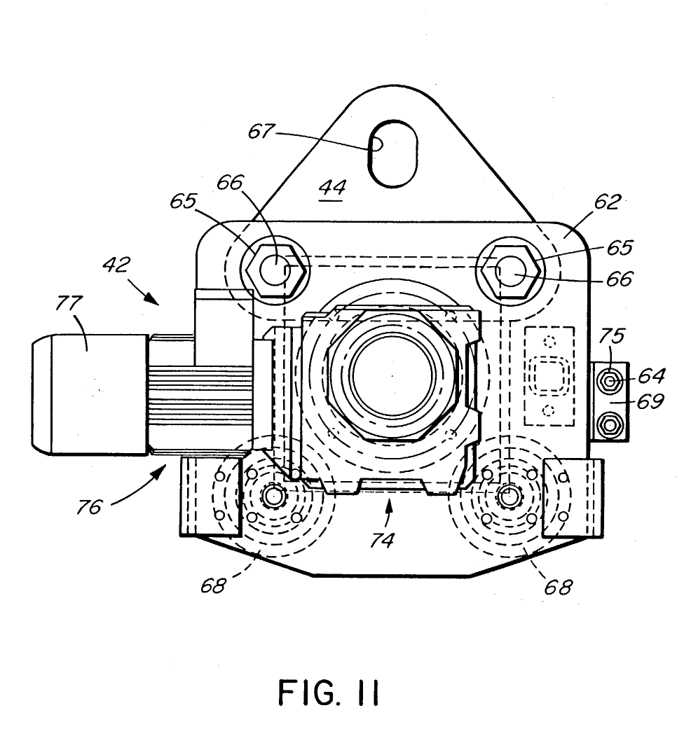

The intermediate section 28, as shown in FIGS. 1 and 9A, is provided with a landing arm, indicated generally by reference numeral 86, which is similar to the landing arm 82 and which is therefore not described in greater detail.

As shown in FIGS. 1 and 5A, the end of the upper truss arm 24 adjacent the intermediate section 24 is provided with an inclined triangular plate 90. Two pairs of connecting lugs 92 are provided at the base of the plate 90, and a projecting spacer 94 is provided at the apex of the triangular plate 90.

The lower truss arm 26, as shown in FIG. 7A, is similarly provided with a triangular plate 96, two pairs of connecting lugs 28 and a spacer 100.

The intermediate section 28, as shown in FIGS. 1, 8 and 9A, is provided, at its ends with triangular plates 102 and 103, which are provided with connecting lugs 104.

By interengaging the connecting lugs 104 of the intermediate section 28 with the connecting lugs 92 of the upper truss arm 24 and the connecting lugs 98 of the lower truss arm 26, and by inserting connecting pins 106 (FIG. 2) through these interengaged lugs to secure them together, the upper and lower truss arms 24 and 28 are secured to the intermediate section 26. The spacers 94 maintain the triangular plate 90 parallel to the adjacent triangular plate 102 and th triangular plate 96 parallel to the triangular plate 103.

The trolley 42 will now be described with reference to FIGS. 11 through 13.

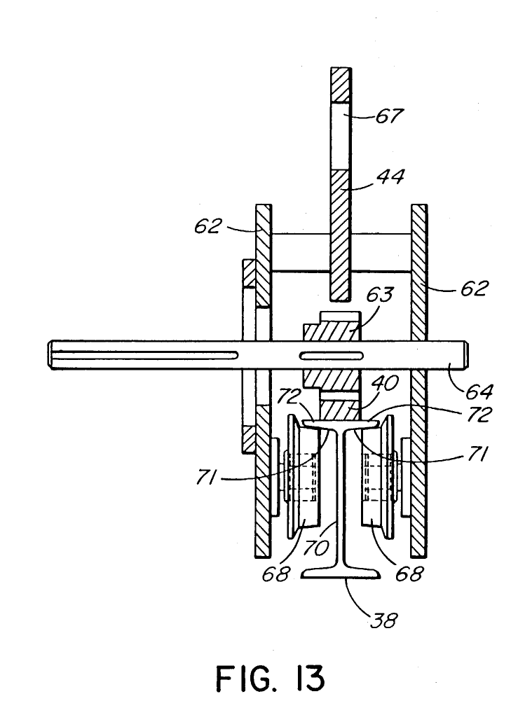

As shown in FIG. 13, a pair of spaced vertical side plates 62 are provided at opposite sides of, and spaced from, a drive pinion 63, which meshes with the rack 40. The drive pinion 63 is fixed on a drive shaft 64. The crane hook connector 44 is a triangular plate which projects upwardly at the top of the trolley 42 and is a formed near its top with an opening 67 for receiving a crane hook (not shown) on the crane cable 43.

The crane hook connector 44 (FIG. 12) is secured to the side plates 62 by nuts 65 threaded on bolts 66 extending through the side walls 26, with spacer sleeves 67 on the bolts 66. The side plates 62 are also connected by bolts 64 extending through brackets 69 welded to the side plates 62, at the front and rear edges of the side plates 62, and nuts 75 on the bolts 64.

Rollers in the form of flanged wheels 68 (FIG. 13) at opposite sides of a web 70 of the I-beam 38, underlie and are in rolling engagement with downwardly facing rolling surfaces 71 on the I-beam 38. The rack 40 and the I-beam 38 form a track extending along the upper arm 24, and the rolling surfaces 71 therefore extend along opposite sides of this track at the undersides of upper flanges 72 of the I-beam 38. A pair of the wheels 68 are freely rotatably journalled on each of the side plates 60.

Rollers 73 (FIG. 12) on the brackets 69 run along the top of the I-beam 38.

The drive shaft 64 is the output shaft of a speed reduction gearing, indicated generally by reference numeral 74 in FIGS. 11 and 12, which is mounted on one of the side plates 62 and interconnects the drive pinion 40 and the electric drive motor 76 (FIG. 11)., provided with a spring-loaded disc brake 77. The trolley 42 is a commercially available trolley manufactures by Norelco Industries Ltd., of Surrey, B.C., Canada and the disc brake 77 is marketed by Danfoss Bauer Ltd., of Mississauga, ON, Canada under Model No. 005 A 09 5 Nm.

L-shaped brackets 78 secured to opposite vertical edges of the side plates 62 below the I-beam flanges 72 serve as abutments which, on meeting counterabutments in the form of brackets 80 (FIGS. 1 and 2) secured to the web 70 of the I-beam 38 at opposite ends of the I-beam 38, limit the movement of the trolley 42 along the I-beam 38.

In the embodiment of the present invention illustrated in FIG. 1, the trolley 42 is controlled from a hand-held control unit 120 connected by a control cable 122 to the control unit 45, and the electric drive motor 76 is supplied with electrical power through a power cable 124 extending from the crane 41.

Alternatively, as illustrated in FIG. 2, the trolley 42 may be remotely controlled from a wireless control and transmitter unit 126 transmitting control signals to an antenna 1128 mounted on the lifting device 12 and connected to a power supply and control unit 130 on the upper truss arm 24.May 16, 2003

I claim

1. A lifting device for a flying form table truss, comprising:
horizontal upper and lower arms extending parallel to one another and each having a free and an opposite end;
a vertical intermediate section connected to the opposite ends;
a crane cable connector on the upper arm; and
an adjustable connection between the crane cable connector and the upper arm, the adjustable connection allowing displacement of the crane cable connector along the upper arm.

2. A lifting device as claimed in claim 1, in which the adjustable connection comprises a track extending along the upper arm, and a trolley engaged with the track and carrying the crane cable connector.

3. A lifting device as claimed in claim 2, in which the track comprises a track extending longitudinally of the upper arm and the trolley has a pinion in meshing engagement with the rack, and electric drive motor and a speed reduction gearing interconnecting the drive motor and the rack.

4. A lifting device as claimed in claim 3, wherein the trolley has a spring-loaded brake.

5. A lifting device as claimed in claim 2, wherein the track has downwardly facing a running surfaces extending along opposite sides of the track and the trolley has rollovers in rolling contact with the running surfaces.

6. A lifting device as claimed in claim 5, in which the track has a I-beam extending longitudinally of the upper arm, the By-beam having up of flanges on which the running surfaces are provided.

7. A lifting device as claimed in claim 6, wherein the track includes a rack extending along and on top of the By-beam, and the trolley has a pinion in meshing engagement with the rack, and electric drive motor and a speed reduction gearing interconnecting the motor and the rack.

8. A lifting device as claimed in claim 1, in which the adjustable connection comprises a track extending along the top of the upper arm and having downwardly facing rolling surfaces along opposite sides of the track, and a self-propelled carriage mounted for movement along the track, the carriage having rollers in rolling engagement with the downwardly facing rolling surfaces, and a crane cable connector mounted on the carriage.

9. A lifting device as claimed in claim 1, including a wireless control arrangement for adjusted the displacing the crane cable connector along the upper arm.

10. A lifting device for a flying form table truss, comprising:
horizontal upper and lower arms extending parallel to one another and each having a free end and an opposite end;
a vertical intermediate section connected to said opposite ends;
a track extending along the top of the upper arm;
the track having downwardly facing rolling surfaces extending along opposite sides of the track; and
a soft-propelled trolley on the track, the trolley having rollers underlying and in rolling contact with the rolling surfaces.

11. A lifting device as claimed in claim 10, wherein the track has a rack and the trolley has a drive pinion meshing with the rack and an electrical drive motor connected to the drive pinion.

12. A lifting device as claimed in claim 11, wherein the trolley includes a speed reduction gearing interconnecting the drive motor and the drive pinion.

13. A lifting device as claimed in claim 12, including a battery on the lifting device for energizing the drive motor and a wireless remote control system, the wireless remote control system having a control transmitter separate from the lifting device and a wireless receiver on the lifting device, a control unit for operating the drive motor in response to control signals transmitted from the control transmitter to the wireless receiver.

14. A lifting device as claimed in claim 10, including remotely visible markings spaced up hot along the upper arm.
